(19) United States
(12) Patent Application Publication
(10) Pub. No.: US 2026/0022242 A1
(43) Pub. Date: Jan. 22, 2026

(54) COMPATIBILIZING AGENTS AND USES THEREOF

(71) Applicant: LORD CORPORATION, Cary, NC (US)

(72) Inventors: Timothy D. Fornes, Apex, NC (US); Mingjun Liu, Cary, NC (US); Glenn J. Glass, Cary, NC (US)

(21) Appl. No.: 18/854,151

(22) PCT Filed: Apr. 7, 2023
(86) PCT No.: PCT/US2023/017862

§ 371 Date: Oct. 4, 2024

Related U.S. Application Data
(60) Provisional application No. 63/328,476, filed on Apr. 7, 2022.

(51) Int. Cl. C08L 71/02; C08G 65/48; C08G 77/388; C08G 77/392; C08K 3/12; C08K 5/315; C08K 5/43; C08L 83/04

(52) U.S. Cl. CPC C08L 71/02; C08K 3/12; C08K 5/315; C08K 5/43; C08L 83/04; C08G 65/48; C08G 77/388; C08G 77/392; C08K 2201/005; C08K 2201/014; C08L 2205/025; C08L 2205/08; C08L 2205/22

(57) ABSTRACT

Compatibilizing agents for use in a wide variety of filled and unfilled liquid matrices and compositions comprising the agents are described. The compatibilizing agents can reduce the viscosity of the matrices and/or improve the stability of the matrices. Exemplary compatibilizing agents include one or more aryl sulfonyl derivatives, such as aryl sufonyl urethanes, aryl sulfonyl ureas, and aryl sulfonamides.

### PRIORITY CLAIM

The present application claims the benefit of U.S. provisional patent application Ser. No. 63/328,476, filed Apr. 7, 2022, the disclosure of which is incorporated herein by reference in its entirety.

### TECHNICAL FIELD

The presently disclosed subject matter relates to compatibilizing agents for use in a variety of applications, such as for enhancing the stability and/or reducing the viscosity of filled and unfilled resins or other liquid-based compositions. Exemplary compatibilizing agents of the presently disclosed subject matter comprise aryl sulfonyl derivatives, such as compounds comprising urethane, urea, and amide derivatives of aryl sulfonyl groups.

### BACKGROUND

Filled polymeric systems have many uses, such as in applications involving thermal or electrical conductivity. For example, electronic components generate heat while they are used and the removal of this heat can help to prevent thermal degradation of the component and to improve or maintain operating efficiency. Thus, for microelectronic components (e.g., integrated circuits), greases, gels, or adhesives comprising thermally conductive fillers such as, but not limited to, micro- and nanoparticles of boron nitride, aluminum nitride, zinc oxide, silicon carbide, and alumina, are often used to remove heat from the component.

The properties of a filled polymeric system can be related not only to the type of polymeric matrix and/or filler used, but also to the amount of filler in the material. Generally, the more filler that is added, the higher the viscosity of the resulting material. Thus, the balance between achieving a particularly desirable property (e.g., electrical or thermal conductivity) through high filler loading while maintaining a workable viscosity is often a trade-off. Many filled polymer systems are dispensed with a syringe and therefore it can be desirable to keep viscosity low enough to allow flow through a needle. In addition, settling of particles (e.g. micron-sized particles), like those used to enhance the thermal conductivity of encapsulants, gap fillers, and adhesives can be an issue that can limit the commercial success of such materials. Settling can occur during the storage and transportation of the materials and, in certain adhesive chemistries, like epoxies or urethanes, can be exacerbated by heat. The result is a material that contains a non-uniform distribution of filler that can be difficult to re-homogenize prior to use and/or that can rapidly settle during use. Mixtures (e.g., polymer blends, polymer resins, oil-in-water or water-in-oil compositions) involving different liquid molecules or macromolecules that are immiscible or partially miscible can also have stability, homogeneity, and/or viscosity issues that can adversely affect the properties and/or ease of use of the mixtures.

Accordingly, there is an ongoing need for agents that can improve the stability, homogeneity, and/or viscosity of liquid-based compositions, including liquid-based compositions comprising solid organic and/or inorganic fillers.

### SUMMARY

This summary lists several embodiments of the presently disclosed subject matter, and in many cases lists variations and permutations of these embodiments. This summary is merely an example of the numerous and varied embodiments. Mention of one or more representative features of a given embodiment is likewise for purposes of example. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

In some embodiments, the presently disclosed subject matter provides a composition comprising: (a) a liquid matrix; (b) a compatibilizing agent, said compatibilizing agent comprising: (b1) one or more first groups, wherein each of the one or more first groups comprises an aryl sulfonyl moiety; and (b2) one or more second groups, wherein each of the one or more second groups comprises an alkyl moiety, a polymeric or oligomeric moiety, or a combination thereof, and wherein each of the one or more second groups is attached to at least one of the one or more first groups; and (c) one or more optional additional components.

In some embodiments, the presently disclosed subject matter provides a method of modifying the viscosity of a polymer resin composition, the method comprising contacting a composition comprising a polymer resin with a compatibilizing agent, wherein said compatibilizing agent comprises: (b1) one or more first groups, wherein each of the one or more first groups comprises an aryl sulfonyl moiety; and (b2) one or more second groups, wherein each of the one or more second groups comprises an alkyl group, a polymeric or oligomeric group, or a combination thereof, and wherein each of the one or more second groups is attached to at least one of the one or more first groups.

In some embodiments, the presently disclosed subject matter provides a method of preparing a polyurethane, wherein the method comprises contacting a composition comprising a polyol and/or an isocyanate resin with a compatibilizing agent, wherein said compatibilizing agent comprises: (b1) one or more first groups, wherein each of the one or more first groups comprises an aryl sulfonyl moiety; and (b2) one or more second groups, wherein each of the one or more second groups comprises an alkyl moiety, a polymeric or oligomeric moiety, or a combination thereof, and wherein each of the one or more second groups is attached to at least one of the one or more first groups.

In some embodiments, the presently disclosed subject matter provides a compound having a structure of one of Formulas (I)-(V): A₁-X₁—Z₁ (I); A₁-X₁—Z₂—X₂-A₁ (II); Z₁—X₂-A₂-X₁—Z₁ (III); A₁-(X₁—Z₂—X₂-A₂)ₙ-X₁—Z₂—X₂-A₁ (IV); and (A₁-X₁)ₚ—Z₃ (V),
wherein: n is an integer of 1 or greater; p is an integer of 3 or greater; each A₁ is aryl or substituted aryl; each A₂ is arylene or substituted arylene; each X₁ is —S(═O)₂—NH—C(═O)-Q- or —S(═O)₂—NH—C(═O)—; each X₂ is -Q-(C═O)—NH—S(═O)₂— or —C(═O)—NH—S(═O)₂—; each Q is O or NH; Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl; Z₂ is alkylene, a polymeric or oligomeric moiety, or a combination thereof; and Z₃ is a multivalent group derived from a compound comprising at least three hydroxy, amino, or carboxylic acid groups.

Accordingly, it is an object of the presently disclosed subject matter to provide compatibilizing agents comprising aryl sulfonyl moieties, compositions comprising the agents, and related methods. These and other objects are achieved in whole or in part by the presently disclosed subject matter. Other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following, example figures. The components in the figures are not necessarily to scale, emphasis instead being placed upon illustrating the principles of the presently disclosed subject matter (often schematically). A further understanding of the presently disclosed subject matter can be obtained by reference to an embodiment set forth in the illustrations of the accompanying drawings. Although the illustrated embodiment is merely for purposes of example of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and provide examples of the presently disclosed subject matter.

For a more complete understanding of the presently disclosed subject matter, reference is now made to the following drawings in which:

FIGS. 1A-1D are schematic diagrams showing the synthesis of three exemplary aryl sulfonyl derivative compatibilizing agents of the presently disclosed subject matter formed from reactions of para-toluene sulfonyl isocyanate (PTSI) with different mono-functional alcohols: monobutyl polypropylene glycol (mPPG, FIG. 1A); isostearyl alcohol (ISA, FIG. 1B); polyethylene glycol oleyl ether (PEGOE, FIG. 1C), or a monocarbinol-terminated polydimethylsiloxane (PDMS, FIG. 1D).

FIG. 2 is a schematic diagram showing exemplary “first” or “head” group chemical structures of the presently disclosed compatibilizing agents.

FIG. 3 is a schematic diagram showing different exemplary configurations of the presently disclosed compatibilizing agents. The “first” groups of the agents are denoted by the circles or letter “B” and the “second” groups by the wavy lines or letter “A”.

FIG. 4 is a graph showing the effect of the amount of compatibilizing agent (measured in weight percent (wt %) of the total organic content in the formulation) on the viscosity (measured in pascal seconds (Pa-s) at a shear rate of 0.5 reciprocal seconds (s⁻¹)) of a polypropylene glycol (PPG) resin highly filled (79 wt %) with aluminum trihydride particles (ATH). The compatibilizing agent is a compatibilizing agent of the presently disclosed subject matter formed from the reaction of para-toluene sulfonyl isocyanate (PSTI) and monobutyl polypropylene glycol (mPPG).

FIG. 5 is a graph showing the effect of shear rate (measured in reciprocal seconds (s⁻¹)) on the viscosity (measured in pascal seconds (Pa-s)) of a polypropylene glycol (PPG) resin highly filled (79 weight percent (wt %)) with aluminum trihydride particles (ATH). Data is shown for formulations comprising 0.41 wt % of compatibilizing agents of the presently disclosed subject matter described in Example 1 (filled triangles), Example 3 (unfilled squares), Example 4 (unfilled circles), or Example 5 (filled squares). For comparison, data is also provided for the formulation without a compatibilizing agent of the presently disclosed subject matter (filled circles).

FIG. 6 is a graph showing the effect of shear rate (measured in reciprocal seconds (s⁻¹)) on the viscosity (measured in pascal seconds (Pa-s)) of a hydrogenated methylene bis(phenyldiisocyanate) (hydrogenated MDI) resin highly filled (79 weight percent (wt %)) with aluminum trihydride particles (ATH). Data is shown for a formulation comprising 0.41 wt % of the compatibilizing agent of Example 6 (unfilled circles) and for the same formulation without a compatibilizing agent of the presently disclosed subject matter (filled circles).

FIG. 7 is a graph showing the effect of shear rate (measured in reciprocal seconds (s⁻¹)) on the viscosity (measured in pascal seconds (Pa-s)) of a polyalphaolefin (PAO) fluid highly filled (78.1 weight percent (wt %)) with iron particles. Data is shown for a formulation comprising 0.6 wt % of the compatibilizing agent of Example 6 (unfilled circles) and for the same formulation without a compatibilizing agent of the presently disclosed subject matter (filled circles).

FIG. 8 is a graph showing the effect of shear rate (measured in reciprocal seconds (s⁻¹)) on the viscosity (measured in pascal seconds (Pa-s)) of a vinyl-terminated polydimethylsiloxane (PDMS) highly filled (84.1 weight percent (wt %)) with aluminum trihydride (ATH) particles. Data is shown for a formulation comprising 0.32 wt % of the compatibilizing agent of Example 7 (unfilled circles) and for a formulation without a compatibilizing agent of the presently disclosed subject matter (filled circles).

### DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments 1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein the term “alkyl” can refer to C₁₋₄₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms or having up to about 5 carbon atoms. “Higher alkyl” refers to an alkyl group having about 10 to about 40 carbon atoms, e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. In some embodiments, there can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds. The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, and the like.

“Heteroaryl” as used herein refers to an aryl group that contains one or more non-carbon atoms (e.g., O, N, S, Se, etc.) in the backbone of a ring structure. Nitrogen-containing heteroaryl moieties include, but are not limited to, pyridine, imidazole, benzimidazole, pyrazole, pyrazine, triazine, pyrimidine, and the like.

The term “monovalent” as used herein refers to a radical of a named chemical group that has one site of attachment to another chemical group.

The term “divalent” as used herein refers to a diradical of a named chemical group that is attached to two other chemical groups. Thus, for example, a “divalent” group can act as a linking group between two other chemical functional groups.

“Alkylene” refers to a straight or branched divalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

“Arylene” refers to a divalent aromatic group.

“Aralkyl” refers to an aryl-alkyl- group wherein aryl and alkyl are as previously described and can include substituted aryl and substituted alkyl. Exemplary aralkyl groups include benzyl, phenylethyl, and naphthylmethyl.

“Aralkylene” refers to a divalent group including both arylene and alkylene moieties.

As used herein, the term “acyl” refers to a carboxylic acid group wherein the —OH of the carboxylic acid group has been replaced with another substituent.

Thus, an acyl group can be represented by RC(═O)—, wherein R is an H, alkyl, substituted alkyl, aralkyl, substituted aralkyl, aryl, or substituted aryl group as defined herein. Specific examples of acyl groups include formyl (i.e., —C(═O)H), acetyl, and benzoyl.

The terms “hydroxyl” and “hydroxyl” refer to the —OH group.

The term “polyol” refers to a compound comprising more than one or more than two hydroxyl groups.

The term “phenol” as used herein can refer to a compound of the formula R—OH group, wherein R is aryl or substituted aryl. Thus, the term “phenolic” refers to a hydroxyl group that is directly attached to an aromatic group, e.g., a phenyl ring, a napthyl ring, etc.

The term “alkoxy” refers to the —OR group wherein R is alkyl or substituted alkyl.

The term “aryloxy” refers to the —OR group wherein R is aryl or substituted aryl.

The terms “mercapto” or “thiol” refer to the —SH group.

The term “carboxyl” refers to the —C(═O)— group.

The terms “carboxylate” and “carboxylic acid” can refer to the groups —C(═O)O— and —C(═O)OH, respectively. In some embodiments, “carboxylate” can refer to either the —C(═O)O— or —C(═O)OH group.

The terms “amide” and “amido” can to the group —C(═O)—NR₁R₂, wherein R₁ and R₂ are independently H, alkyl, substituted alkyl, aralkyl, substituted aralkyl, aryl or substituted aryl. Polyamides can include —C(═O)—NR₁— linkages in a polymer chain.

The terms “carbamate” and “urethane” refer to the group —O—C(═O)—NR—, wherein R is H, alkyl, substituted alkyl, aralkyl, substituted aralkyl, aryl, or substituted aryl.

The term “urea” refers to the group —NR₁—C(═O)—NR₁—, wherein each R₁ is independently H, alkyl, substituted alkyl, aralkyl, substituted aralkyl, aryl, or substituted aryl.

The term “ester” refers to a compound including the group —C(═O)—O—R, wherein R is alkyl, aralkyl, or aryl. Polyesters can include —C(═O)—O— linkages in a polymer chain. Thus, the term “polyester” can refer to a polymer comprising ester linkages in the polymer main chain.

The term “ether” refers to a compound including the group —R—O—R—, wherein each R is alkylene or arylene.

The terms “epoxy”, “epoxide” and “oxirane” as used herein refer to chemical functional group comprising a three-membered ring structure comprising one oxygen atom and two carbon atoms that are bonded together via single bonds. Thus, an epoxy group can have the structure:

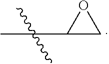 [SMILES: *C1CO1]

The term “aryl sulfonyl” as used herein refers to an aryl-S(═O)₂— group, wherein the aryl can be optionally substituted with one or more aryl group substituents. The term “aryl sulfonyl derivative” as used herein can refer to a compound or group wherein another chemical functional group (e.g., an amide, an urea, an urethane, an oxo group, etc.), are directly attached to the sulfur atom of the aryl sulfonyl group.

The term “silyl” refers to groups comprising silicon atoms (Si). For example, a silyl group can have the formula —Si(R)₃, wherein each R is selected from H, alkyl, aralkyl, and aryl. An exemplary silyl group is a trialkyl silyl group, e.g., trimethyl silyl.

As used herein, the terms “siloxy” and “silyl ether” refer to groups or compounds including a silicon-oxygen (Si—OR) bond and wherein R is an organic group, such as a substituted or unsubstituted alkyl or aryl group (i.e., methyl, ethyl, phenyl, etc.). In some embodiments, the terms refer to compounds comprising one, two, three, or four alkoxy, aralkoxy, or aryloxy groups bonded to a silicon atom. Each alkyloxy, aralkoxy, or aryloxy group can be the same or different.

The term “polysiloxane” refers to a polymer comprising a backbone having alternating silicon and oxygen atoms, where the silicon atoms are substituted with functional groups, such as alkyl, aralkyl, or aryl groups.

As used herein the terms “microparticle” and “nanoparticle” have the meaning that would be ascribed to them by one of ordinary skill in the art. In some embodiments, “microparticle” can refer to a particle having a dimension (e.g., a width or diameter) ranging from about 1000 microns down to about 0.1 microns. In some embodiments, the microparticle has a dimension ranging from about 100 microns to about 1 micron. In some embodiments, “nanoparticle” refers to a particle having a dimension ranging from about 1 micron to about 0.1 nm. In some embodiments, the nanoparticle has a dimension ranging from about 500 nm to about 1 nm. In some embodiments, the nanoparticle has a dimension that is smaller than about 200 nm, such as but not limited to about 100 nm. Micro- and nanoparticles can be any shape, e.g., cubic, spherical, or irregularly shaped.

As used herein, a “monomer” or a “polymerizable monomer” refer to a molecule that can undergo polymerization, thereby contributing constitutional units, i.e., a repeating atom or group of atoms, to the essential structure of a polymer or oligomer.

As used herein, a “polymer” refers to a molecule which comprises the multiple repetition of units derived from molecules of low relative molecular mass, e.g., polymerizable monomers and/or oligomers. In some embodiments, a polymer has at least 10, at least 50, or at least 100 repeating units.

An “oligomer” refers to a polymeric molecule of intermediate relative molecular mass, the structure of which comprises a small plurality (e.g., 2-10) of units derived from molecules of lower relative molecular mass.

A “copolymer” refers to a polymer derived from more than one species of polymerizable monomer. Copolymers include block copolymers (containing chains of oligomers or polymers where each chain is an oligomeric or polymeric chain based on a different monomeric unit), random copolymers, where monomeric units from different monomers are randomly ordered in the copolymer, and statistical copolymers, where there is a statistical distribution of monomeric units from the different monomers in the copolymer chain.

A polymer blend refers to a mixture to two different types of polymer or copolymer.

A “chain” refers to the whole or part of a polymer or an oligomer comprising a linear or branched sequence of constitutional units between two boundary constitutional units, wherein the two boundary constitutional units can comprise an end group, a branch point, or combinations thereof. A “main chain” or “backbone” refers to a chain from which all other chains are regarded as being pendant. A “side chain” refers to a smaller chain attached to the main chain. In some embodiments, a side chain can contain a single, non-repeating constitutional unit.

The terms “resin” and “polymer resin” as used herein refer to both reactive and non-reactive resins. For example, the term resin can refer to a composition comprising a monomer, an oligomer, a polymer, or mixtures thereof that can be converted to form a more rigid polymeric matrix, e.g., via a hardening or curing process. Resins can comprise viscous substances or mixtures of viscous substances. Additionally or alternatively, resins can comprise a compound or compounds that can be dissolved in another resin component or in a solvent that can be evaporated or otherwise removed during and/or after the hardening or curing process. Thus, in some embodiments, the term resin refers to a composition comprising a polymerizable monomer that is a liquid at a temperature and/or pressure suitable for deployment of the resin prior to hardening or curing (e.g., room temperature and atmospheric pressure) or that can be dissolved in a suitable solvent. The term resin can also refer to oligomers and/or polymers that can undergo cross-linking reactions and/or additional polymerization to form higher molecular weight compounds. The term resin can also refer to non-reactive resins that are not capable of forming covalent bonds though polymerization or crosslinking. Such non-reactive resins can comprise one or more oligomeric or polymeric species.

The term “organic solvent” as used herein can refer to both polar and non-polar aprotic solvents typically used in the field of organic synthesis and including one or more carbon atom. The term “aprotic solvent” refers to a solvent molecule which can neither accept nor donate a proton. Examples of aprotic solvents include, but are not limited to, ethyl acetate; carbon disulphide; ethers, such as, diethyl ether, tetrahydrofuran (THF), ethylene glycol dimethyl ether, dibutyl ether, diphenyl ether, MTBE, and the like; aliphatic hydrocarbons, such as hexane, pentane, cyclohexane, and the like; aromatic hydrocarbons, such as benzene, toluene, naphthalene, anisole, xylene, mesitylene, and the like; and symmetrical halogenated hydrocarbons, such as carbon tetrachloride, tetrachloroethane, and dichloromethane. Additional aprotic solvents include, for example, acetone, acetonitrile, butanone, butyronitrile, chlorobenzene, chloroform, 1,2-dichloroethane, dimethylacetamide, N,N-dimethylformamide (DMF), dimethylsulfoxide (DMSO), and 1,4-dioxane.

### II. Representative Embodiments

In some embodiments, the presently disclosed subject matter provides a family of compounds that can be used as compatibilizing agents in a wide variety of applications. For example, the presently disclosed compounds can be used as surfactants, emulsifiers, foaming agents, adhesion promoters, wetting agents, and/or dispersing agents. In some embodiments, the presently disclosed compounds can be used to modify the viscosity of liquid mixtures and/or suspensions, such as paints, coatings, inks, cleaning solutions, cosmetic fluids or emollients, lubricants (e.g., high-temperature lubricants, compressor lubricants, refrigeration lubricants, machinery lubricants, two-cycle lubricants, rubber lubricants, mill and calender lubricants, greases and solid lubricants, textile fiber lubricants, textile machine lubricants, etc.), magneto rheological fluids, adhesives, or drilling fluids, among others. In some embodiments, the compounds can be used to modify the coefficient of friction (COF) of a liquid and a solid.

In an exemplary embodiment described herein, compatibilizing agents of the presently disclosed subject matter can be used to improve the stability and/or reduce the viscosity of a filled polyol and/or isocyanate resin system, such as a resin system for the preparation of a highly filled, thermally conductive urethane. In addition to improved viscosity reduction compared to surfactants typically used in such systems, the presently disclosed compatibilizing agents can also improve shelf-life and cure stability of urethanes and provide for the use of a high concentration of fillers, including lower cost filler and/or fillers having a higher surface area. However, the presently disclosed agents are not limited to use in filled polymeric matrices but can also be used in unfilled polymeric systems and in non-polymeric liquid matrices.

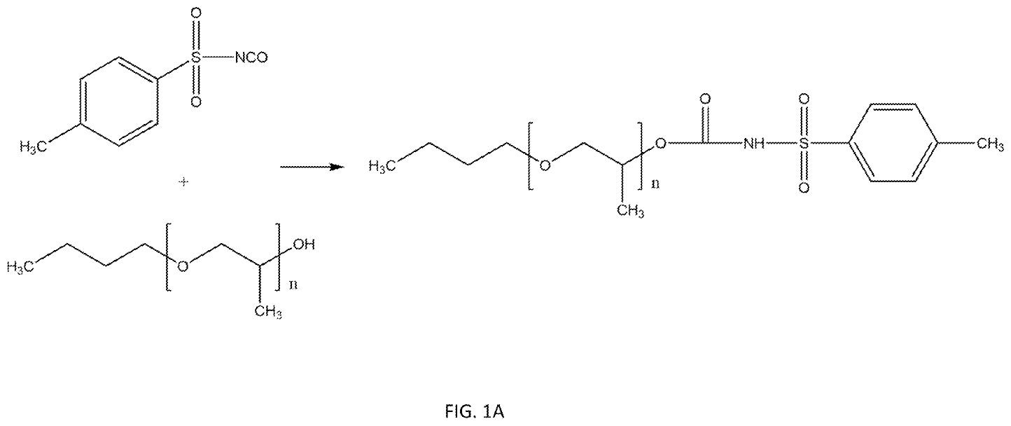

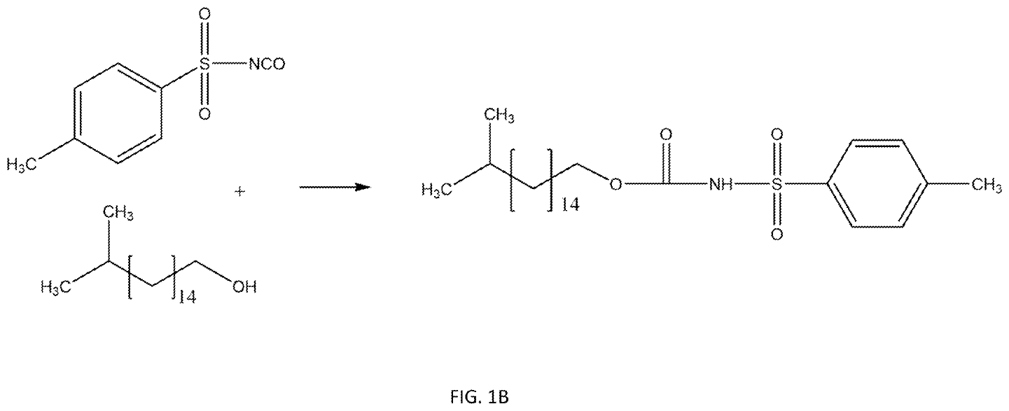

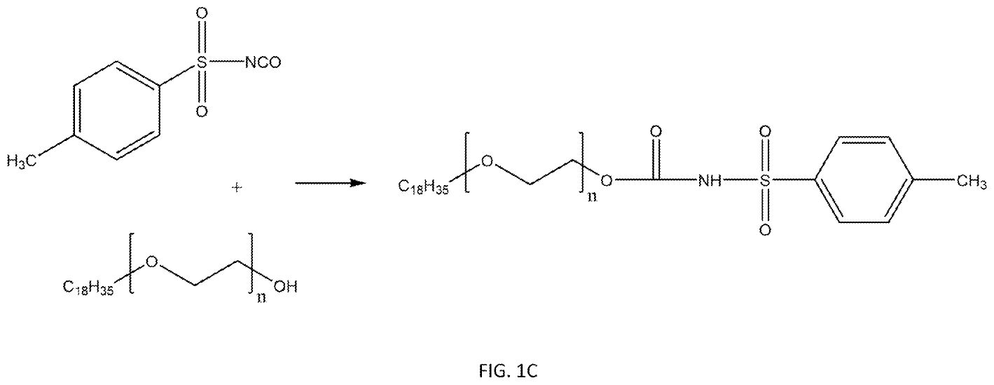

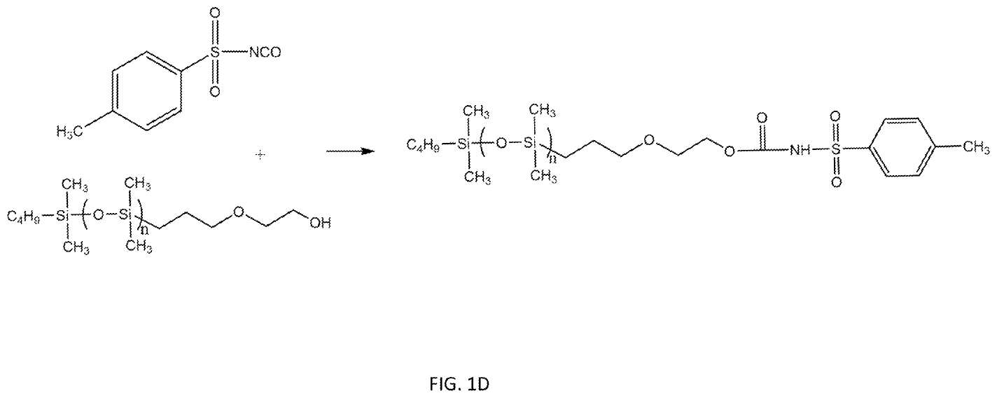

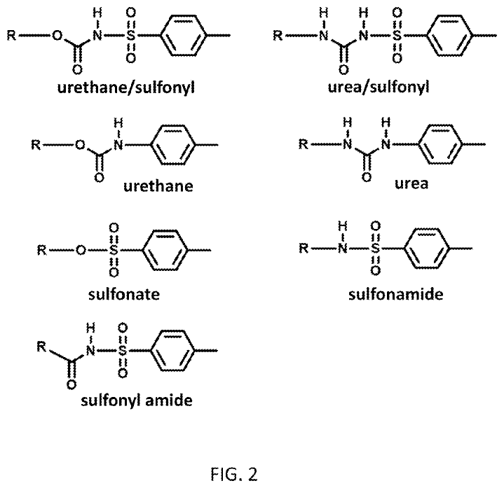

In some embodiments, the presently disclosed compatibilizing agent can be a reaction product of (i) an amine, an alcohol, or a carboxylic acid and (ii) an aryl isocyanate (e.g., para-toluene isocyanate (PTI)) or an aryl sulfonyl isocyanate (e.g., para-toluene sulfonyl isocyanate (PTSI). Thus, for example, the compatibilizing agent can comprise one or more first groups, wherein the one or more first groups are selected from an aryl sulfonyl urethane (i.e., a group having the formula aryl-S(═O)₂—NH—C(═O)—O—), an aryl sulfonyl urea (i.e., a group having the formula aryl-S(═O)₂—NH—C(═O)—NH—), an aryl sulfonyl amide (i.e., a group having the formula aryl-S(═O)₂—NH—C(═O)—), an aryl sulfonamide (i.e., a group having the formula aryl-S(═O)₂—NH—), an aryl sulfonate (i.e., a group having the formula aryl-S(═O)₂—O—), and an aryl urethane (i.e., a group having the formula aryl-NH—C(═O)—O—), and an aryl urea (i.e., a group having the formula aryl-NH—C(═O)—NH—). FIGS. 1A-1D show synthetic schemes for the synthesis of exemplary compatibilizing agents of the presently disclosed subject matter prepared from the reaction of PTSI and different mono-alcohols (or “monols”). In some embodiments, the PTSI and the monol (or other alcohol) can be contacted to one another to form the compatibilizing agent under conditions where the ratio of isocyanate (NCO) equivalents to hydroxyl equivalents (OH) is about 0.5:1 NCO:OH to about 1.5:1 NCO:OH. For example, in some embodiments, more NCO equivalents than OH equivalents can be used to off-set possible reactions of NCO groups with residual water that can be present in the monol. In some embodiments the ratio NCO:OH can be about 1:1. A ratio of about 0.5:1 NCO:reactive group to about 1.5:1 NCO:reactive group can be used when the aryl isocyanate is reacted with an amine or a carboxylic acid instead of an alcohol. FIG. 2 shows general chemical structures for compatibilizing agents of the presently disclosed subject matter, showing the different types of first group functionalities in the case where the aryl group is methyl-substituted phenyl.

More generally, the presently disclosed compounds can include one or more “first” or “head” groups and one or more “second” or “tail” groups, wherein each of the one or more second groups is attached to at least one or the one or more first groups. The one or more first groups can provide interaction between the compatibilizing agent and polar surfaces (e.g., the polar surfaces of inorganic filler particles) or polar groups in liquids. For example, in some embodiments, the first group can interact with inorganic filler particles via pi bonding between metal ions in the inorganic filler and the aryl moiety of the first group and/or via hydrogen bonding and/or dipole interactions between the inorganic filler and heteroatoms in the first group. The one or more second groups can be selected based upon an intended use of the compatibilizing agent. For instance, in some embodiments, the second group chemistry can be tailored to having similar chemistry to, or to be otherwise compatible with one or more components of a liquid matrix in which the compatibilizing group is to be used, e.g., to enhance interaction of the compatibilizing agent and the liquid matrix. In some embodiments, the one or more second groups can comprise an alkyl group (e.g., an alkyl group from a fatty acid or fatty alcohol), a polymeric or oligomeric group, or any combination thereof. In some embodiments, the polymeric moiety of the second group is selected from a polyether, a polysiloxane, a polyacrylate, a polyester, and a polyolefin.

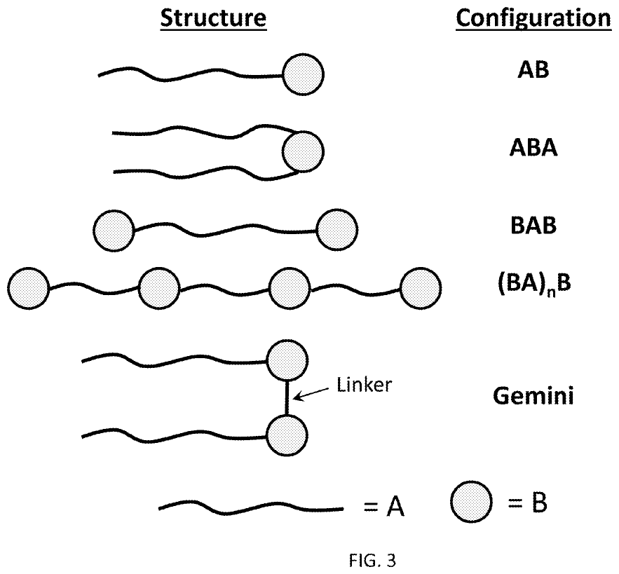

The first and second groups of the presently disclosed compatibilizing agent can be provided in a variety of different configurations. Exemplary configurations of first groups (B) and second groups (A) are shown in FIG. 3. For example, the agent can include one first group and one second group (the “AB configuration” of FIG. 3), two second groups attached to the same first group (the “ABA configuration” of FIG. 3), two first groups attached to the same second group (the “BAB configuration” of FIG. 3), an alternating series of first and second groups (e.g., the “(BA)ₙB configuration” of FIG. 3) or a dimeric configuration where two AB configuration sub-units are attached to one another via one or more linker groups, e.g., between the two first groups or between the two second groups (i.e., a “gemini configuration” such as that shown in FIG. 3. The gemini configuration compatibilizing agents of the presently disclosed subject matter can comprise linkage chemistries and configurations analogous to those of gemini surfactants known in the art. See e.g., Sekhon, B. S. (Resonance, 42-49 (2004)).

In some embodiments, the compatibilizing agent comprises one or more first groups each comprising a moiety that comprises an aryl sulfonyl derivative. Thus, in some embodiments, the one or more first groups each comprises an aryl sulfonyl urethane, an aryl sulfonyl urea, an aryl sulfonyl amide, an aryl sulfonamide, or an aryl sulfonate. In some embodiments, the compatibilizing agent is a compound having a structure of one of Formulas (I)—(V):

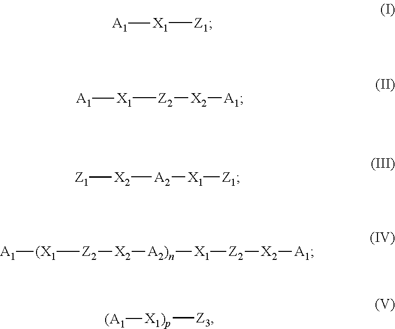

wherein: n is an integer of 1 or greater; p is an integer of 3 or more; each A₁ is aryl or substituted aryl (e.g., phenyl or substituted phenyl); each A₂ is arylene or substituted arylene (e.g., phenylene or substituted phenylene); each X₁ is —S(═O)₂—NH—C(═O)-Q- or —S(═O)₂—NH—C(═O)—; each X₂ is -Q-(C═O)—NH—S(═O)₂— or —C(═O)—NH—S(═O)₂—; each Q is O or NH; Z₁ is selected from alkyl (e.g., a branched or straight chain C6-C40 alkyl) and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl; Z₂ is alkylene, a polymeric moiety, or a combination thereof; and Z₃ is a multivalent group derived from a compound comprising at least three hydroxy, amino, or carboxylic acid groups (i.e., a multivalent group formed when at least three hydroxy, amino, or carboxylic acid groups of a parent compound react with sulfonyl isocyanate groups to form X₁ linkages).

In some embodiments, the compatibilizing agent can be prepared by reacting an aryl sulfonyl isocyanate or aryl di-sulfonyl isocyanate and a mono-functional alcohol (i.e., a “monol”), an amine, or a polyol. For example, in some embodiments, the compatibilizing agent can be prepared by reacting an aryl sulfonyl isocyanate (e.g., PTSI) and a polyol, such as a polyoxyethylene (POE) sorbitan monooleate or another saccharide derivative, and the compatibilizing agent can have the structure of Formula (V):

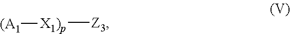

wherein each A₁ is aryl or substituted aryl; each X₁ is —S(═O)₂—NH—C(═O)—O—; p is an integer of 3 or more, and Z₃ is a multivalent derivative of a polyol (i.e., a polyol derivative wherein at least three hydroxyl groups of a parent polyol have reacted with sulfonyl isocyanate groups to form X₁ linkages, wherein the oxygen atoms of the hydroxyl groups of the parent polyol are the oxygen atoms attached to the carboxyl groups in the X₁ linkages).

In some embodiments, the compatibilizing agent comprises one first group and one second group and is a compound of Formula (I):

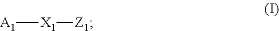

wherein: A₁ is aryl or substituted aryl; X₁ is —S(═O)₂—NH—C(═O)—O—, —S(═O)₂—NH—C(═O)—NH—, or —S(═O)₂—NH—C(═O)—; and Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl. In some embodiments, A₁ is phenyl or substituted phenyl (e.g., alkyl-substituted phenyl). In some embodiments, A₁ is methyl-substituted phenyl.

In some embodiments, the compatibilizing agent is a reaction product of para-toluene sulfonyl isocyanate (PTSI) and a mono-functional alcohol (i.e., a monol). Thus, in some embodiments, X₁ is —S(═O)₂—NH—C(═O)—O— and the compatibilizing agent is a compound comprising a first group of the formula:

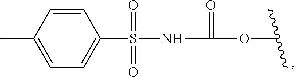 [SMILES: *OC(=O)NS(=O)(=O)c1ccc(C)cc1]

i.e., referred to herein as a toluene sulfonyl urethane.

In some embodiments, Z₁ is alkyl. In some embodiments, Z₁ is a C6-C40 alkyl group (e.g., a C6, C8, C10, C12, C14, C16, C18, C20, C22, C24, C26, C28, C30, C32, C34, C36, C38, or C40 alkyl). For example, in some embodiments, Z₁ is a monovalent derivative of a branched or straight chain fatty alcohol, e.g., 3-methyl pentanol, heptanol, octanol, pelargonic alcohol, capric alcohol, undecyl alcohol, lauryl alcohol, tridecyl alcohol, myristyl alcohol, pentadecyl alcohol, cetyl alcohol, palmitolyl alcohol, heptadecyl alcohol, stearyl alcohol, oleyl alcohol, nonadecyl alcohol, arachidyl alcohol, and the like. In some embodiments, Z₁ is isostearyl.

In some embodiments, Z₁ is -(L₂)ₛ-(L₃)ₜ-R₁, wherein s is 0 or 1; t is 1; L₂ is alkylene (e.g., C1, C2, C3, C4, C5, C6, C7, C8, C9, C10, C11, or C12 alkylene), L₃ is a polymeric group, and R₁ is alkyl or silyl. In some embodiments, L₃ is a polymeric or oligomeric group, such as, but not limited to, a polyether, a polysiloxane, a polyacrylate, a polyester, and a polyolefin. In some embodiments, L₃ is a polyether or polysiloxane group. In some embodiments, L₃ is a combination of different polymeric or oligomeric groups, i.e., wherein L₃ can have blocks of two or more different types of polymeric or oligomeric groups. In some embodiments, the polyether is a polyether polyol moiety. In some embodiments, the polyether is a polyalkylene glycol moiety, such as a polyethylene glycol (PEG) or polypropylene glycol (PPG) moiety. In some embodiments, R₁ is a C1-C6 alkyl group, e.g., methyl, ethyl, n-propyl, isopropyl, n-butyl, sec-butyl, tert-butyl, n-pentyl, or n-hexyl. In some embodiments, R₁ is a larger alkyl group, e.g., a C8-C40 alkyl group, which can be branched or straight-chain, and optionally include one or more carbon-carbon double bonds. In some embodiments, R₁ is a silyl group (e.g., trimethylsilyl). In some embodiments, Z₁ is an alkyl-terminated polyether polyol or a silyl-terminated alkylene-polysiloxane moiety (e.g., a C1-C6 alkylene-PDMS moiety, terminated by an alkyl-substituted silyl group, such as trimethylsilyl, or an alkyl group).

In some embodiments, the compatibilizing agent is one of the group comprising:

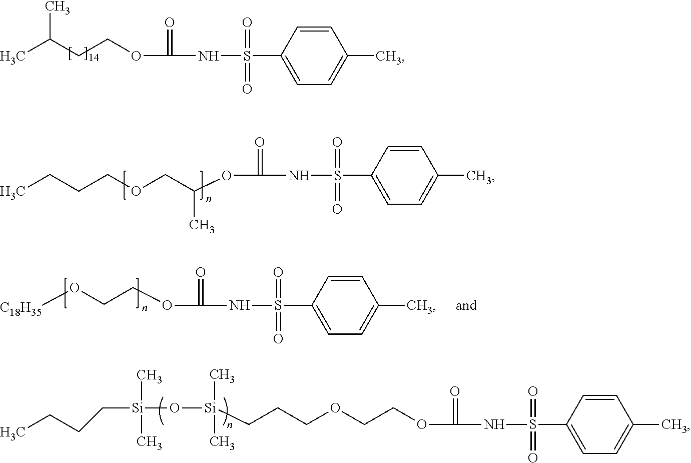

where n is a variable greater than 1. In some embodiments, n is a variable between 2 and 5,000, between 2 and 1,000, between 2 and 500, between 2 and 100, or between 2 and 50. In some embodiments, n is 5 or greater. In some embodiments, n is 10 or greater.

In some embodiments, the presently disclosed subject matter provides a composition comprising the compatibilizing agent and at least one liquid molecule. Thus, in some embodiments, the presently disclosed subject matter provides a composition compatibilized with a compatibilizing agent of the presently disclosed subject matter. In some embodiments, the composition comprises: (a) a liquid matrix; (b) a compatibilizing agent of the presently disclosed subject matter (i.e., a compatibilizing agent comprising: (b1) one or more first groups, wherein each of the one or more first groups comprises an aryl sulfonyl moiety; and (b2) one or more second groups, wherein each of the one or more second groups comprises an alkyl moiety, a polymeric or oligomeric moiety, or a combination thereof and wherein each of the one or more second groups is attached to at least one of the one or more first groups); and (c) one or more optional additional components. In some embodiments, the polymeric moiety of (b2) is selected from the group comprising a polyether (e.g., a polyether polyol), a polysiloxane, a polyacrylate, a polyester, and a polyolefin (e.g., a polyalphaolefin (PAO)).

In some embodiments, the compatibilizing agent (b) has a structure of one of Formulas (I)—(V) described hereinabove. In some embodiments, the compatibilizing agent has a structure of Formula (I):

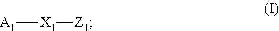

wherein: A₁ is aryl or substituted aryl; X₁ is —S(═O)₂—NH—C(═O)—O—, —S(═O)₂—NH—C(═O)—NH—, or —S(═O)₂—NH—C(═O)—; Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl. In some embodiments, A₁ is phenyl or methyl-substituted phenyl. In some embodiments, the compatibilizing agent is the reaction product of PTSI and a monol, an amine or a carboxylic acid.

Liquid matrix (a) can comprise any liquid, a solution, or mixture of liquids that can benefit from the presence of the presently disclosed compatibilizing agent, either alone or when combined with optional additional component (c), which can be an additional liquid or a solid component. In some embodiments, the liquid matrix comprises or consists of one or more oligomers or polymers. For example, in some embodiments, the liquid matrix comprises or consists of a polymer such as a polyether, a polyester, or a PAO (e.g., a polyolefin prepared from the polymerization of a 1-alkene, such as 1-hexene or 1-octene, or polyethylene copolymers thereof). In some embodiments, the liquid matrix comprises one or more monomers, such as an amine, an alcohol, an isocyanate, a polyol, or a combination thereof. In some embodiments, the liquid matrix comprises water. In some embodiments, the liquid matrix comprises an organic solvent (e.g., a polar or non-polar aprotic organic solvent), an oil, or a combination thereof. In some embodiments, the liquid matrix comprises a hydrocarbon fluid. In some embodiments, the liquid matrix can comprise a combination of any of these liquids and/or include one or more solute, e.g., such as a dye or other colorant, an anti-oxidant, a UV-stabilizer, a polymerization catalyst, etc.

For example, in some embodiments, the liquid matrix comprises a reactive or non-reactive resin. In some embodiments, the resin comprises both monomeric and polymeric and/or oligomeric compounds, where the compounds are liquids at a temperature and/or pressure suitable for application or use of the resin or where the compounds are soluble in a suitable solvent such that the resin compounds can be provided in a solution. In some embodiments, the resin comprises compounds that are liquid at room temperature or that are soluble in a solvent at room temperature. In some embodiments, the liquid matrix comprises an urethane resin, silicone resin, an acrylic resin, an epoxy resin, or a silyl-terminated resin.

More particularly, suitable liquid epoxy resins can comprise an epoxy material containing at least one epoxy functional group. The epoxy resin can be monofunctional, difunctional, multifunctional and combinations thereof. The epoxy can be aliphatic, cycloaliphatic, aromatic, or the like. In some embodiments the epoxy resin comprises liquid epoxy resins based on diglycidyl ether of bisphenol A (DGEBA) or diglycidyl ether of bisphenol-F (DGEBF). Liquid epoxy resins typically comprise a molecular weight of less than about 500 Daltons and preferably between about 150 and 600 Daltons. Molecular weight can be determined by methods known in the art, such as gel permeation (or size exclusion) chromatography.

Acrylic resins can comprise an acrylic material containing at least one acrylate and/or methacrylate functional group. The acrylic resin can be monofunctional, difunctional, multifunctional, or combinations thereof as long as the resulting material blend is a liquid at room temperature. Representative monofunctional acrylic resins comprise esters of (meth)acrylic acid such as methyl methacrylate, ethyl methacrylate, butyl methacrylate, methyl acrylate, butyl acrylate, cyclohexyl acrylate, hexyl acrylate, 2-ethyl hexyl acrylate, lauryl acrylate, ethyl acrylate, dicyclopentadienyloxyethyl meth acrylate, cyclohexyl methacrylate, lauryl methacrylate, glycidyl methacrylate and tetrahydrofurfuryl methacrylate (THFMA). Other monofunctional resins include OH-functional monoethylenic unsaturated monomers like 3-hydroxypropyl (meth)acrylate, 4-hydroxy butyl (meth)acrylate, 4-hydroxycyclohexyl(meth)acrylate, 1,6-hexanediol mono(meth) acrylate, neopentyl glycol mono(meth)acrylate.

In some embodiments, the composition comprises one or more optional additional components (c). In some embodiments, the one or more optional additional components comprise solid organic and/or inorganic particles (e.g., nanoparticles and/or microparticles) and/or fibers (e.g., nanofibers). In some embodiments, the composition comprises about 1 weight (wt) % to about 95 wt % of an additional solid component(s) or about 1 volume (vol) % to about 80 vol % of the optional additional solid component(s). For instance, “highly filled” resins can comprise about 35% to about 95% by weight of solid filler particles and/or fibers. Thus, in some embodiments, the composition comprises about 35 wt % to about 95 wt % (e.g., about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %) of a solid filler particle or fiber or a combination of solid filler particles and/or fibers (e.g., wherein the combination can comprise differently-sized particles of the same chemical composition, combinations of particles of different chemical compositions, or combinations of particles of different chemical compositions and different sizes). In some embodiments, the composition comprises about 65 wt % to about 90 wt % of a solid filler particle or fiber or a combination of solid filler particles and/or fibers. In some embodiments, (c) comprises particles and/or fibers comprising one or more of the group including, but not limited to, silicon dioxide, fumed silica, fused silica, talc, mica, wollastonite, calcium carbonate, carbon, a polymer, aluminum, aluminum trihydride (ATH), iron, silver, a metal oxide, boron nitride and aluminum nitride.

In some embodiments, the optional additional component (c) comprises an additional liquid component, e.g., wherein said additional liquid component is a liquid that is incompatible with (e.g., immiscible or only partially miscible with) liquid matrix (a). For example, in some embodiments, (a) comprises water and (c) comprises an oil (e.g., any non-polar, hydrocarbon-based liquid). In some embodiments, (a) comprises a non-polar liquid and (c) comprises water. In some embodiments, when (c) comprises a liquid component, (c) comprises at least about 1 wt % but less than about 50 wt % (or less than about 40 wt %, less than about 30 wt %, less than about 25 wt %, less than about 20 wt %, less than about 15 wt %, or less than about 10 wt %) of the total weight of the composition.

In some embodiments, the compatibilizing agent (b) has a structure of Formula (I):

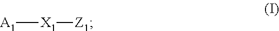

wherein: A₁ is aryl or substituted aryl; X₁ is —S(═O)₂—NH—C(═O)—O—, —S(═O)₂—NH—C(═O)—NH—, or —S(═O)₂—NH—C(═O)—; Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl. In some embodiments A₁ is phenyl or substituted phenyl. In some embodiments, A₁ is alkyl-substituted phenyl (e.g., methyl-substituted phenyl).

In some embodiments, Z₁ is alkyl. In some embodiments, Z₁ is a C6-C40 alkyl group (e.g., a C6, C8, C10, C12, C14, C16, C18, C20, C22, C24, C26, C28, C30, C32, C34, C36, C38, or C40 alkyl). For example, in some embodiments, Z₁ is a monovalent derivative of a branched or straight chain fatty alcohol, e.g., 3-methyl pentanol, heptanol, octanol, pelargonic alcohol, capric alcohol, undecyl alcohol, lauryl alcohol, tridecyl alcohol, myristyl alcohol, pentadecyl alcohol, cetyl alcohol, palmitolyl alcohol, heptadecyl alcohol, stearyl alcohol, oleyl alcohol, nonadecyl alcohol, arachidyl alcohol, and the like. In some embodiments, Z₁ is isostearyl.

In some embodiments, compatibilizing agents where Z₁ is alkyl are provided in compositions where (a) comprises a resin, such as an epoxy resin or a resin comprising an isocyanate. In some embodiments, compatibilizing agents where Z₁ is alkyl are present in compositions where (a) comprises a PAO or water. In some embodiments, compatibilizing agents where Z₁ is alkyl are included in compositions when optional additional component (c), such as an organic and/or inorganic particle or fiber (e.g., ATH or iron particles), is present. In some embodiments, compatibilizing agents where Z₁ is alkyl are present in compositions where an optional additional component (c) is absent.

In some embodiments, Z₁ is -(L₂)ₛ-(L₃)ₜ-R₁, wherein s is 0, t is 1, L₃ is a polyether polyol, and R₁ is alkyl (e.g., C1-C6 alkyl). Thus, for example, Z₁ can comprise a polyether polyol moiety such as a polypropylene moiety, terminated by a lower alkyl group (e.g., methyl, ethyl, propyl, or butyl). In some embodiments, compatibilizing agents where Z₁ comprises a polyether polyol are present in a composition wherein (a) comprises a polyol. In some embodiments, the composition further comprises organic and/or inorganic particles and/or fibers.

In some embodiments, Z₁ is -(L₂)ₛ-(L₃)ₜ-R₁, wherein s is 1, t is 1, L₂ is alkylene (e.g., C1-C6 alkylene, optionally including an oxygen atom inserted in the alkylene group), L₃ is a polysiloxane moiety, and R₁ is silyl (e.g., trialkylsilyl). In some embodiments, the compatibilizing agent where L₃ comprises a polysiloxane moiety can be used in a composition wherein (a) comprises PDMS. In some embodiments, the composition further comprises solid particles and/or fibers, e.g., ATH particles.

In some embodiments, the compatibilizing agent has a structure of Formula (Ia):

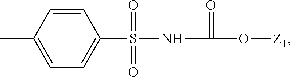

wherein Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl.

In some embodiments, the composition comprises one of the compositions selected from the group comprising (i)-(vi), where:
(i) A₁ is methyl-substituted phenyl, X₁ is —S(═O)₂—NH—C(═O)—O—, and Z₁ is -(L₂)ₛ-(L₃)ₜ-R₁ where s is 0, t is 1, L₃ is a polyether polyol moiety, and R₁ is methyl; liquid matrix (a) comprises a polyether polyol; and optional additional component (c) comprises one or more organic and/or inorganic particles (e.g., ATH particles);
(ii) A₁ is methyl-substituted phenyl, X₁ is —S(═O)₂—NH—C(═O)—NH—, and Z₁ is -(L₂)ₛ-(L₃)ₜ-R₁ where s is 0, t is 1, L₃ is a polyether polyol, and R₁ is methyl; liquid matrix (a) comprises a polyether polyol; and optional additional component (c) comprises one or more organic and/or inorganic particles (e.g., ATH particles);
(iii) A₁ is methyl-substituted phenyl, X₁ is —S(═O)₂—NH—C(═O)—O—, and Z₁ is isostearyl; liquid matrix (a) comprises a PAO; and optional additional component (c) comprises one or more organic and/or inorganic particles (e.g., iron particles);
(iv) A₁ is methyl-substituted phenyl, X₁ is —S(═O)₂—NH—C(═O)—O—, and Z₁ is -(L₂)ₛ-(L₃)ₜ-R₁ where s is 1, t is 1, L₂ is —CH₂CH₂—OCH₂CH₂CH₂—, L₃ is a PDMS moiety, and R₁ is silyl; liquid matrix (a) comprises a silicone resin; and optional additional component (c) comprises one or more organic and/or inorganic particles (e.g., ATH particles);
(v) A₁ is methyl-substituted phenyl, X₁ is —S(═O)₂—NH—C(═O)—O—, and Z₁ is isostearyl; liquid matrix (a) comprises an isocyanate (e.g., HDMI); and optional additional component (c) comprises one or more organic and/or inorganic particles (e.g., ATH particles); and
(vi) A₁ is methyl-substituted phenyl, X₁ is —S(═O)₂—NH—C(═O)—O—, and Z₁ is polyoxyethylene (5) oleyl ether; and wherein liquid matrix (a) comprises water; and optional additional component (c) comprises a PAO.

As noted hereinabove, the compositions of the presently disclosed subject matter can find use in a variety of different applications. In some embodiments, the composition is selected from the group including, but not limited to, a paint, a coating, a cleaning solution, a lubricant, a magneto rheological fluid, an adhesive, a drilling fluid, a cosmetic fluid, and an ink.

In some embodiments, the presently disclosed subject matter provides a method of modifying the viscosity of a polymer resin (or other liquid) composition, wherein the method comprises contacting a composition comprising a polymer resin (or other liquid) with a compatibilizing agent of the presently disclosed subject matter (e.g., a compatibilizing agent comprising one or more first groups, wherein each of the one or more first groups comprises an aryl sulfonyl moiety; and one or more second groups, wherein each of the one or more second groups comprises an alkyl group, a polymeric group, or a combination thereof, and wherein each of the one or more second groups is attached to at least one of the one or more first groups). In some embodiments, the compatibilizing agent has a structure of one of Formulas (I)—(V) as described hereinabove. In some embodiments, the compatibilizing agent has a structure of Formula (I). In some embodiments, the compatibilizing agent has a structure of Formula (Ia).

In some embodiments, the polymer resin comprises a polyol, an isocyanate, an amine, a polysiloxane, a PAO, an epoxy resin, an acrylic resin, or a combination thereof.

In some embodiments, the polymer resin is a filled polymer resin, i.e., comprising solid organic and/or inorganic particles and/or fibers as described hereinabove (e.g., micro- and/or nanoparticles and/or nanofibers comprising one or more of silicon dioxide, fumed silica, fused silica, talc, mica, wollastonite, calcium carbonate, carbon black, carbon fibers, polymer fibers, aluminum, aluminum trihydride (ATH), iron, silver, a metal oxide, boron nitride and aluminum nitride). In some embodiments, the polymer resin composition comprises about 35 wt % to about 95 wt % of solid organic and/or inorganic particles and/or fibers.

In some embodiments, modifying the viscosity of the polymer resin (or other liquid composition) comprises reducing the viscosity of the polymer resin (or other composition) e.g., compared to the same composition in the absence of the compatibilizing agent. In some embodiments, viscosity is reduced in comparison to the viscosity of the same composition comprising a traditional surfactant or other type of compatibilizing agent instead of the compatibilizing agent of the presently disclosed subject matter.

While the compatibilizing agent of the presently disclosed subject matter can usually be selected to reduce viscosity, in some embodiments, a compatibilizing agent can be selected to provide shear thinning or thixotropic rheological behavior to a resin or other composition. In some embodiments, a compatibilizing agent can be selected to increase viscosity, e.g., by selecting a compatibilizing agent having a second group or groups that has a structure that is dissimilar to and/or immiscible or partially miscible with the liquid matrix.

In some embodiments, the presently disclosed subject matter provides a method of preparing a polyurethane. In some embodiments, the method comprises contacting a composition comprising a polyol and/or an isocyanate resin with a compatibilizing agent of the presently disclosed subject matter (e.g., wherein said compatibilizing agent comprises: one or more first groups, wherein each of the one or more first groups comprises an aryl sulfonyl moiety; and one or more second groups, wherein each of the one or more second groups comprises an alkyl moiety, a polymeric moiety, or a combination thereof, and wherein each of the one or more second groups is attached to at least one of the one or more first groups). In some embodiments, the compatibilizing agent has a structure of one of Formulas (I)—(V) as described hereinabove. In some embodiments, the compatibilizing agent has a structure of Formula (I). In some embodiments, the compatibilizing agent has a structure of Formula (Ia).

Polyurethanes can be prepared, for example, by reacting an isocyanate, e.g., a diisocyanate, with a polyol, e.g., a difunctional polyol, to prepare an isocyanate-terminated prepolymer. In some embodiments, the polyurethane can be prepared by directly reacting an isocyanate with a polyol without forming a prepolymer. Suitable isocyanates for use in preparing polyurethanes according to the presently disclosed subject matter include, but are not limited to aromatic, aliphatic, and cycloaliphatic polyisocyanates, for example, isophorone diisocyanate (IPDI), hexamethylene diisocyanate (HDI), methylenebis(phenyl diisocyanate) (MDI), 4,4′-methylene dicyclohexyl diisocyanate (HMDI or H₁₂MDI, a monomeric cycloaliphatic isocyanate, m-phenylene diisocyanate, 2,4- and/or 2,6-toluene diisocyanate (TDI), hexamethylene 1,6-diisocyanate, tetramethylene-1,4-diisocyanate, cyclohexane-1,4-diisocyanate, hexahydrotoluene diisocyanate, naphthylene-1,5-diisocyanate, methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4′-diisocyanate, 4,4′,4″-triphenylmethane diisocyanate, polymethylene polyphenylisocyanate, toluene-2,4,6-trilsocyanate, and 4,4′-dimethyldiphenylmethane-2,2′,5,5′-tetraisocyanate and a polymeric MDI, as well as mixtures and blends thereof.

Suitable polyols include compounds such as, but not limited to, alkylene glycols (e.g., ethylene glycol, propylene glycol, 1,4-butane diol, 1,6 hexanediol and the like), glycol ethers and polyethers, for example difunctional polyether polyols, such as diethylene glycol, triethylene glycol, dipropylene glycol, tripropylene glycol and the like, glycerine, trimethylolpropane, tertiary amine-containing polyols such as triethanolamine, triisopropanolamine, and ethylene oxide and/or propylene oxide adducts of ethylene diamine, toluene diamine and the like, polyether polyols, carbonates and the like, and mixtures and blends thereof. Polyester polyols are also suitable, including reaction products of polyols, e.g., diols, with polycarboxylic acids or their anhydrides, such as dicarboxylic acids or dicarboxylic acid anhydrides. The polycarboxylic acids or anhydrides can be aliphatic, cycloaliphatic, aromatic and/or heterocyclic and can optionally be substituted, such as with halogen atoms. The polycarboxylic acids can also be unsaturated. Examples of these polycarboxylic acids include, but are not limited to, succinic acid, adipic acid, terephthalic acid, isophthalic acid, trimellitic anhydride, phthalic anhydride, maleic acid, maleic acid anhydride and fumaric acid.

In some embodiments, the composition comprises both an isocyanate and a polyol. The ratio of the two components can be selected to provide a desired isocyanate index (ratio of isocyanate to isocyanate-reactive groups, e.g., hydroxyl groups of the polyol). In some embodiments, the isocyanate and polyol components are mixed such that the index of isocyanate to hydroxyl (NCO:OH) equivalents is from about 0.3 to about 1.5 (e.g., 0.3, 0.4, 0.5, 0.6, 0.7, 0.8, 0.9, 1.0, 1.1, 1.2, 1.3, 1.4, or about 1.5). In some embodiments, the composition can further include a catalyst, e.g., an amine catalyst or an organometallic catalyst (e.g., a tin-containing organometallic catalyst.

In some embodiments, the method further comprises contacting the composition comprising the polyol and/or the isocyanate resin with one or more organic and/or inorganic filler particles (e.g., micro- and/or nanoparticles) and/or fibers (e.g., nanofibers). Suitable organic and/or inorganic filler particles and/or fibers include, but are not limited to silicon dioxide, fumed silica, fused silica, talc, mica, wollastonite, calcium carbonate, carbon black, carbon fibers, polymer fibers, aluminum, aluminum trihydride (ATH), iron, silver, a metal oxide, boron nitride and aluminum nitride. In some embodiments, the method can comprises contacting the composition comprising the polyol and/or the isocyanate with more than one type of organic or inorganic filler particles or with more than one size of organic or inorganic filler particles.

In some embodiments, the compatibilizing agent is contacted to the composition comprising the polyol and/or isocyanate resin in an amount of about 0.05 wt % to 49 vol % based on the total weight of liquid comprising the composition comprising the polyol and/or isocyanate resin and the compatibilizing agent. In some embodiments, the compatibilizing agent is contacted to the polyol and/or isocyanate resin in an amount of about 0.5 wt % to about 12 wt % (e.g., about 0.5, 1.0, 1.5, 2.0, 2.5, 3.0, 4.0, 5.0, 6.0, 7.0, 8.0, 9.0, 10.0, 11.0, or about 12.0 wt %) based on the total weight of liquid comprising the composition comprising the polyol and/or isocyanate resin and the compatibilizing agent. In some embodiments, the compatibilizing agent is contacted to the polyol and/or isocyanate resin in an amount of about 0.5 wt % to about 3.0 wt % based on the total weight of liquid in the composition. In some embodiments, the compatibilizing agent is contacted to the composition in an amount of about 0.1 wt % to about 2 wt % based on the total weight of the composition.

The presently disclosed compatibilizing agent can provide a number of advantages when used in place of a traditional surfactant or other type of compatibilizing agent used in resins comprising polyols and/or isocyanates. For example, the presently disclosed compatibilizing agent can provide improved stability in view of its lack of reactivity. Acid esters, such as those traditionally used in these types of resins can undesirably react with isocyanate groups, and can thus result in increased viscosity and reduced resin shelf-life. The presently disclosed compatibilizing agent can also have less interaction with the catalysts used in these resins. In contrast, acid esters can complex with the catalysts, thereby inhibiting or delaying curing. The improved efficiency afforded by the use of the presently disclosed compatibilizing agents can also lead to less plasticization of the resulting cured polyurethane matrix. Plasticization can be undesirable as it can compromise the mechanical properties of the polyurethane. Additionally, the presently disclosed compatibilizing agent can provide for higher filler loadings and/or the use of fillers with higher surface areas. The presently disclosed compatibilizing agents are also easy to synthesize. The reaction of PTSI and monols, for example, is rapid and has no significant side products.

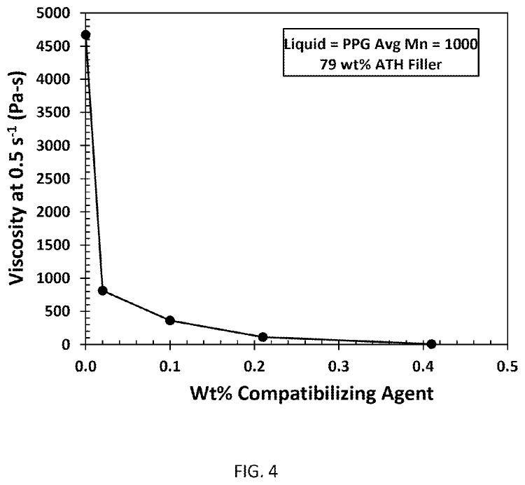

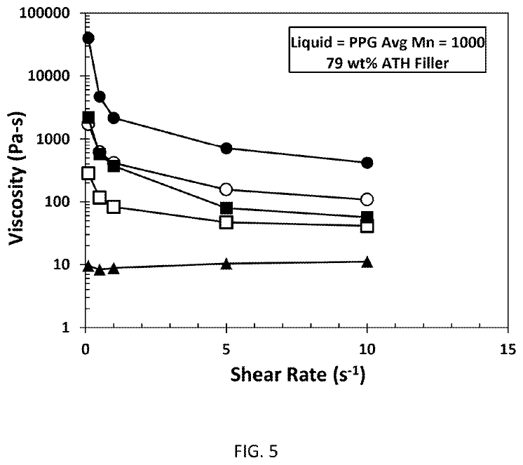

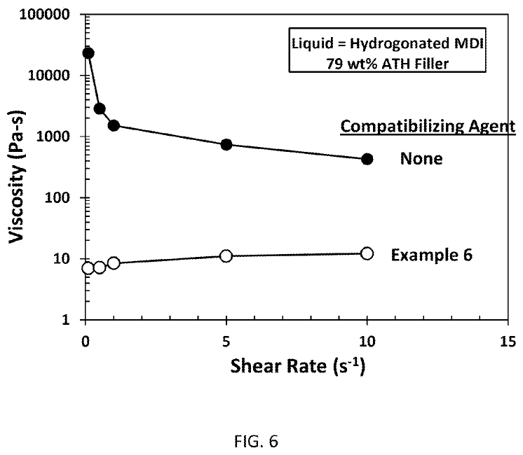

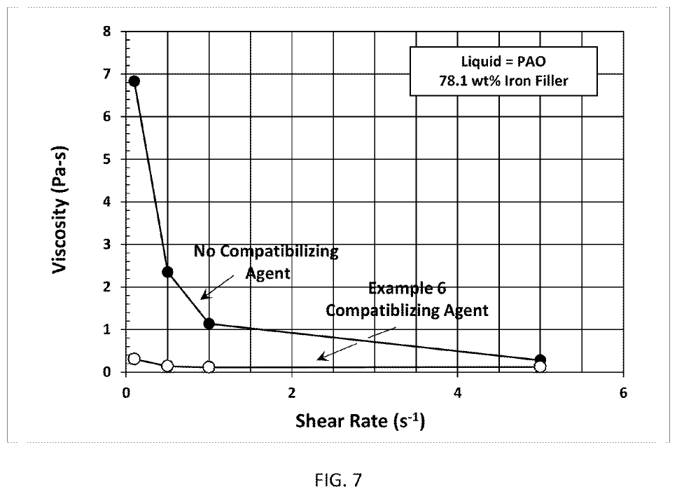

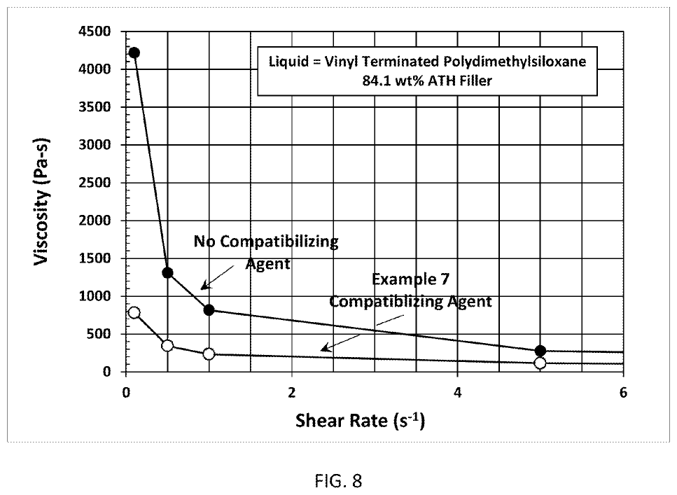

Some of the improved effects of the presently disclosed compatibilizing agents are shown in FIGS. 4-8. For instance, FIG. 4 shows the effect of the amount of a compatibilizing agent of the presently disclosed subject matter on the viscosity of a polyol resin (i.e., a polypropylene glycol (PPG) resin) highly filled with 79 wt % ATH particles at the same shear rate, while FIG. 5 shows the effect of different compatibilizing agents of the presently disclosed subject matter on the viscosity of the same filled resin system at different shear rates. The compatibilizing agents of FIG. 5 have various “second groups” based on, for example, i.e., an alkyl-terminated PPG monol (Example 1), an amine-derivative of a PPG (Example 3), polyoxyethylene (POE) (4) lauryl ether (Example 4), and POE (20) sorbitan monooleate (Example 5). FIGS. 6-8 show the effect of exemplary compatibilizing agents of the presently disclosed subject matter on viscosity in different liquid matrices, i.e., a highly filled hydrogenated MDI resin (FIG. 6), a filled PAO fluid (FIG. 7), and a vinyl-terminated PDMS resin (FIG. 8). The flat Newtonian behavior of the formulations comprising the compatibilizing agents is a reflection of the agents' strong ability to wet and disperse the fillers within the liquid matrices.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Examples 1-8

A series of example compatibilizing agents were prepared. The reactants used to prepare the agents and their corresponding weight percentages in the different agents are summarized in Table 1, below. The example compatibilizing agents were synthesized according to the following general procedure:

Reactant A was added to a 60 mL glass jar equipped with a magnetic stir bar and a dry nitrogen inlet/outlet flow line. Reactant B was then incrementally added over the course of approximately 30 minutes while stirring Reactant A under a steady flow of dry nitrogen. The amount of Reactant B was based on a stoichiometric portion of reactive groups with a total final target mass of 20 g. Stirring was continued for at least another 60 minutes following the completion of the reaction which was verified by Fourier-transform infrared (FTIR) spectroscopy.

TABLE 1
Exemplary Compatibilizing Agents.

| | | Wt % | | Wt % |
|---|---|---|---|---|
| | | Reactant | | Reactant |
| Example | Reactant B | B | Reactant A | A |
| 1 | PTSI | 20.1 | PPG monobutyl ether | 79.9 |
| | | | (Avg Mn = 740) | |
| 2 | PTSI | 6.9 | PPG monobutyl ether | 93.1 |
| | | | (Avg Mn = 2490) | |
| 3 | PTSI | 24.7 | Monoamine-terminated PPG | 75.3 |
| | | | (Avg Mn = 600) | |
| 4 | PTSI | 35.2 | Polyoxyethylene (4) lauryl ether | 64.8 |
| | | | (Avg Mn = 362) | |
| 5 | PTSI | 31.1 | Polyoxyethylene (PEO) (20) | 68.9 |
| | | | sorbitan monooleate | |
| | | | (Avg Mn = 1310) | |
| 6 | PTSI | 42.2 | Isostearyl alcohol | 57.8 |
| 7 | PTSI | 1.9 | Monocarbinol-terminated PDMS | 98.1 |
| | | | (Avg Mn = 10,000) | |
| 8 | PTSI | 28.7 | PEO (5) oleyl ether | 71.3 |
| | | | (Avg Mn = 489) | |

### Examples 9-30

Table 2 provides a summary of control and exemplary formulations used to show the viscosity reducing ability of embodied compatibilizing agents. Molecular sieve powder (particle size=5 microns, sieve pore diameter=4 Angstroms) was used in selected formulations to remove any water brought in by the liquid resin and/or fillers. Formulations were prepared by mixing the ingredients under vacuum using a DAC 800 HAUSCHILD SPEEDMIXER™ (Hauschild GmbH & Co., KG; Hamm, Germany) according to the weight percentages listed in Table 2. Steady-shear viscosity of each formulation was measured as function of shear rate at 25° C. using a TA Discovery rheometer (TA Instruments, New Castle, Delaware, United States of America) equipped with a 20 mm parallel plate geometry set at a 0.5 mm gap. Results are reported in Table 3, below.

TABLE 2
Exemplary Formulations Comprising Compatibilizing Agents of Examples 1-8.

| | | Compatibilizing | | | |
|---|---|---|---|---|---|
| Example | Liquid Matrix | Agent | Drying Agent | Additional Component | Additional Component |
| 9 (control) | 21.51 wt % PPG (1000 MW) | NA | 0.54 wt % Mol sieves | 57.44 wt % ATH, D50 = | 21.51 wt % ATH, D50 = 1 μm |
| | | | | 15.5 μm | |
| 10A | 20.49 wt % PPG (1000 MW) | 0.02 wt % Ex. 1 | 0.45 wt % Mol sieves | 57.44 wt % ATH, D50 = | 21.51 wt % ATH, D50 = 1 μm |
| | | | | 15.5 μm | |
| 10B | 20.41 wt % PPG (1000 MW) | 0.10 wt % Ex. 1 | 0.54 wt % Mol sieves | 57 44 wt % ATH, D50 = | 21.51 wt % ATH, D50 = 1 μm |
| | | | | 15.5 μm | |
| 10C | 20.3 wt % PPG (1000 MW) | 0.21 wt % Ex. 1 | 0.54 wt % Mol sieves | 57.44 wt % ATH, D50 = | 21.51 wt % ATH, D50 = 1 μm |
| | | | | 15.5 μm | |
| 10D | 20.10 wt % PPG (1000 MW) | 0.41 wt % Ex. 1 | 0.54 wt % Mol sieves | 57.44 wt % ATH, D50 = | 21.51 wt % ATH, D50 = 1 μm |
| | | | | 15.5 μm | |
| 11 | 20.10 wt % PPG (1000 MW) | 0.41 wt % Ex. 2 | 0.54 wt % Mol sieves | 57.44 wt % ATH, D50 = | 21.51 wt % ATH, D50 = 1 μm |
| | | | | 15.5 μm | |
| 12 (control) | 11.33 wt % PPG (1000 MW) | NA | 0.54 wt % Mol sieves | 66.07 wt % Aluminum | 22.06 wt % Aluminum oxide |
| | | | | oxide (D50 = 70 μM) | (D50 = 7 μM) |
| 13 | 10.92 wt % PPG (1000 MW) | 0.41 wt % Ex. 1 | 0.54 wt % Mol sieves | 66.07 wt % Aluminum | 22.06 wt % Aluminum oxide |
| | | | | oxide (D50 = 70 μM) | (D50 = 7 μM) |
| 14 | 20.10 wt % PPG (1000 MW) | 0.41 wt % Ex. 3 | 0.54 wt % Mol sieves | 57.44 wt % ATH, D50 = | 21.51 wt % ATH, D50 = 1 μm |
| | | | | 15.5 μm | |
| 15 | 19.87 wt % PPG (1000 MW) | 0.42 wt % Ex. 4 | 0.38 wt % Mol Sieves | 57.60 wt % ATH, D50 = | 21.73 wt % ATH, D50 = 1 μm |
| | | | | 15.5 μm | |
| 16 | 19.83 wt % PPG (1000 MW) | 0.42 wt % Ex. 5 | 0.54 wt % Mol sieves | 57.51 wt % ATH, D50 = | 21.70 wt % ATH, D50 = 1 μm |
| | | | | 15.5 μm | |
| 17 (control) | 20.51 wt % HMDI | NA | 0.54 wt % Mol sieves | 57.44 wt % ATH, D50 = | 21.51 wt % ATH, D50 = 1 μm |
| | | | | 15.5 μm | |
| 18 | 20.10 wt % HMDI | 0.41 wt % Ex. 6 | 0.54 wt % Mol sieves | 57.44 wt % ATH, D50 = | 21.51 wt % ATH, D50 = 1 μm |
| | | | | 15.5 μm | |
| 19 (control) | 8.69 wt % HMDI | NA | 0.54 wt % Mol sieves | 68.07 wt % Aluminum | 22.70 wt % Aluminum oxide |
| | | | | oxide (D50 = 70 μM) | (D50 = 7 μM) |
| 20 | 8.28 wt % HMDI | 0.41 wt % Ex. 6 | 0.54 wt % Mol sieves | 68.07 wt % Aluminum | 22.70 wt % Aluminum oxide |
| | | | | oxide (D50 = 70 μM) | (D50 = 7 μM) |
| 21 (control) | 21.9 wt % PAO (2.5 cSt) | NA | NA | 78.1 wt % Iron powder | NA |
| 22 | 21.3 wt % PAO (2.5 cSt) | 0.6 wt % Ex. 6 | NA | 78.1 wt % Iron powder | NA |
| 23 (control) | 15.32 wt % Vinyl-terminated | NA | 0.54 wt % Mol sieves | 60.94 wt % ATH, D50 = | 23.2 wt % ATH, D50 = 1 μm |
| | PDMS (100 cSt) | | | 15.5 μm | |
| 24 | 15 wt % Vinyl-terminated | 0.32 wt % Ex. 7 | 0.54 wt % Mol sieves | 60.94 wt % ATH, D50 = | 23.2 wt % ATH, D50 = 1 μm |
| | PDMS (100 cSt) | | | 15.5 μm | |
| 25 (control) | 20.57 wt % silyl-terminated | NA | 0.54 wt % Mol sieves | 57.39 wt % ATH, D50 = | 21.49 wt % ATH, D50 = 1 μm |
| | polyethers (7.0 Pa-s) | | | 15.5 μm | |
| 26 | 20.1 wt % silyl-terminated | 0.41 wt % Ex. 3 | 0.54 wt % Mol sieves | 57.44 wt % ATH, D50 = | 21.51 wt % ATH, D50 = 1 μm |
| | polyethers (7.0 Pa-s) | | | 15.5 μm | |
| 27 (control) | 91.9 wt % water | NA | NA | 8.1 wt % PAO (2.5 cSt) | NA |
| 28 | 91.1 wt % water | 0.8 wt % Ex. 8 | | 8.1 wt % PAO (2.5 cSt) | NA |
| 29 (control) | 100 wt % PAO (2.5 cSt) | NA | NA | NA | NA |
| 30 | 98 wt % PAO (2.5 cSt) | 2 wt % Ex. 6 | NA | NA | NA |

TABLE 3
Steady Shear Viscosity (in pascal-seconds
(Pas) of Formulations of Examples 7-26.

| | Shear Rate | | | | |
|---|---|---|---|---|---|
| Example | 0.1 s⁻¹ | 0.5 s⁻¹ | 1 s⁻¹ | 5 s⁻¹ | 10 s⁻¹ |
| 9 (control) | 39861 | 4671 | 2156 | 710 | 417 |
| 10A | 5414 | 815 | 461 | 164 | 98 |
| 10B | 1029 | 363 | 259 | 79 | 57 |
| 10C | 54 | 114 | 92 | 31 | 27 |
| 10D | 10 | 8 | 9 | 10 | 11 |
| 11 | 908 | 336 | 242 | 76 | 40 |
| 12 (control) | 5649 | 3089 | 1789 | 603 | 291 |
| 13 | 414 | 191 | 142 | 80 | 63 |
| 14 | 283 | 116 | 83 | 47 | 41 |
| 15 | 1721 | 612 | 412 | 155 | 108 |
| 16 | 2183 | 577 | 371 | 79 | 57 |
| 17 (control) | 23154 | 2861 | 1513 | 736 | 426 |
| 18 | 7 | 7 | 8 | 11 | 12 |
| 19 (control) | 28192 | 1325 | 516 | 97 | 53 |
| 20 | 8 | 10 | 9 | 11 | 12 |
| 21 (control) | 6.83 | 2.35 | 1.14 | 0.28 | NA |
| 22 | 0.31 | 0.14 | 0.11 | 0.12 | NA |
| 23 (control) | 4218 | 1308 | 815 | 277 | 191 |
| 24 | 780 | 342 | 232 | 115 | 80 |
| 25 | 12886 | 5032 | 3464 | 1900 | 1324 |
| 26 | 6615 | 3601 | 2648 | 1345 | 921 |

Examples 9 (control) and 10 show the effect of adding the compatibilizing agent based on Example 1 derived from the reaction with para-toluene sulfonyl isocyanate (PTSI) and polypropylene glycol monobutyl ether (M̅ₙ=740) to a polypropylene glycol (PPG M̅ₙ=1000) liquid matrix filled with aluminum trihydrate (ATH) particles. The viscosity over all shear rates drops dramatically over all shear rates with the incorporation of the compatibilizing agent. The level of viscosity decrease increases with increasing compatibilizing agent concentration (Examples 10A-10D) with approximately an order of magnitude decrease at the highest concentration. Moreover, the viscosity data for Example 10D exhibits Newtonian behavior, which reflects good wetting by the Example 1 compatibilizing agent and dispersion of the filler throughout the liquid matrix.

Example 11 shows the effect of adding a compatibilizing agent based on Example 2, derived from the reaction with PTSI and higher molecular weight polypropylene glycol monobutylether (M̅ₙ=2490), to a PPG (M̅ₙ=1000) liquid matrix filled with ATH particles. As seen in Table 3, Example 11 data shows an order of magnitude reduction of viscosity relative to the PPG/ATH control (Example 9).

Examples 12 (control) and 13 show the effect of adding a compatibilizing agent based on Example 2, derived from the reaction with PTSI and higher molecular weight polypropylene glycol monobutylether (M̅ₙ=2490), to a PPG (M̅ₙ=1000) liquid matrix filled with aluminum oxide particles. The viscosity of Example 13 is lower by about 13 to 8 times that of the control.

Example 14 in comparison to its control, Example 9, shows the effect of adding the compatibilizing agent based on Example 3 derived from the reaction with PTSI and monoamine terminated polypropylene glycol (Avg M̅ₙ=600) to a polypropylene glycol liquid (PPG M̅ₙ=1000) matrix filled with ATH particles. The viscosities of Example 14 range from approximately 140 to 10 times lower than of the Example 9 formulation containing no compatibilizing agent.

Example 15 in comparison to its control, Example 9, shows the effect of adding the compatibilizing agent based on Example 4 derived from the reaction with PTSI and polyoxyethylene (4) lauryl ether (Avg M̅ₙ=362) to a polypropylene glycol liquid (PPG M̅ₙ=1000) matrix filled with ATH particles. The viscosities of Example 15 range from approximately 23 to 4 times lower than of the Example 9 formulation containing no compatibilizing agent.

Example 16 in comparison to its control, Example 9, shows the effect of adding the compatibilizing agent based on Example 5 derived from the reaction with PTSI and polyoxyethylene (20) sorbitan monoleate (Avg M̅ₙ=1310) to a polypropylene glycol liquid (PPG M̅ₙ=1000) matrix filled with ATH particles. The viscosities of Example 16 range from approximately 18 to 7 times lower than of the Example 9 formulation containing no compatibilizing agent.

Examples 17 (control) and 18 show the effect of adding the compatibilizing agent based on Example 6 derived from the reaction with PTSI and isostearyl alcohol to HMDI liquid matrix filled with ATH particles. The viscosity drops dramatically, i.e. 2-3 orders of magnitude, over all shear rates with the incorporation of the compatibilizing agent. Moreover, the viscosity data for Example 18 exhibits Newtonian behavior, which reflects good wetting by the Example 6 compatibilizing agent and dispersion of the filler throughout the liquid matrix.

Examples 19 (control) and 20 show the effect of adding the compatibilizing agent based on Example 6 derived from the reaction with PTSI and isostearyl alcohol to HDMI liquid matrix filled with aluminum oxide particles. The viscosity over all shear rates drops dramatically over all shear rates with the incorporation of the compatibilizing agent. Moreover, the viscosity data exhibits Newtonian behavior, which reflects good wetting by the Example 6 compatibilizing agent and dispersion of the filler through the liquid matrix.

Examples 21 (control) and 22 show the effect of adding the compatibilizing agent based on Example 6 derived from the reaction with PTSI and isostearyl alcohol to a 2.5 centistoke polyalphaolefin (PAO-2.5) liquid matrix filled with iron particles. The viscosity over all shear rates drops about 2- to 22-fold over all shear rates with the incorporation of the compatibilizing agent.

Examples 23 (control) and 24 show the effect of adding the compatibilizing agent based on Example 7 derived from the reaction with PTSI and monocarbinol terminated polydimethylsiloxane (Avg M̅ₙ=10,000) to a 100 centistoke, vinyl terminated polymethylsiloxane liquid matrix filled with ATH. The viscosity overall shear rates drops nominally 2- to 5-fold over all shear rates with the incorporation of the compatibilizing agent.

Example 26 in comparison to its control, Example 25, shows the effect of adding the compatibilizing agent based on Example 3 derived from the reaction with PTSI and monoamine terminated polypropylene glycol (Avg M̅ₙ=600) to a silyl-terminated polyether (viscosity=7.0 Pa-s) matrix filled with ATH particles. The viscosities of Example 26 range from approximately 1.9 to 1.4 times lower than of the Example 25 formulation containing no compatibilizing agent.

Examples 27 (control) and 28 were prepared by adding the following to a 4 oz glass jar per the weight percentages listed in Table 2: deionized water (liquid matrix), PAO-2.5 fluid, and optionally the compatibilizing agent based on Example 8 derived from the reaction with PTSI and polyoxyethylene (5) oleyl ether (Avg M̅ₙ=489). The target total mass for Examples 27 and 28, with and without compatibilizing agent, respectively, was 60 grams. The formulations were then mixed at room temperature for 10 minutes at 1800 rpm using a Caframo mixer (Caframo, Wiarton, Ontario, Canada) equipped with a 25.4 mm diameter Cowles disperser blade. Immediately after stopping the mixer, the mixture was monitored for stability. Example 27 showed immediate phase separation of the PAO-2.5 fluid from the water with the PAO forming a distinct clear layer on top of the clear water phase beneath. In contrast, Example 28 exhibited a uniform, opaque-white appearance through the entire mixture indicating the Example 8 compatibilizing agent's ability to create an oil in water emulsion. The mixture showed signs of some phase separation after approximately an hour; however, the top and bottom phases remained opaque-white.

Examples 29 (control) and 30 were prepared, according to Table 2, to compare the effect of adding 2 wt % by weight Example 6 compatibilizing agent based on the reaction between PTSI and isostearyl alcohol on the coefficient of friction on stainless steel. Example 30 was specifically prepared by adding 29.4 g and 0.6 g of PAO-2.5 liquid matrix and Example 6 compatibilizing agent, respectively, to a 2 oz glass jar. The jar was capped placed on rollers for 16 hours overnight to ensure complete mixing. Coefficient of friction (COF) measurements were performed for the pure PAO fluid (Example 29) and the one containing Example 6 compatilizing agent (Example 30) using a Discovery ARES rheometer (TA Instruments, New Castle, Delaware, United States of America) equipped with a stainless steel, ring-on-plate configuration. Example 30 blend exhibited a COF value of 0.16, approximately 29% lower than the 0.23 value for the PAO fluid alone.

It will be understood that various details of the presently disclosed subject matter may be changed without departing from the scope of the presently disclosed subject matter. Furthermore, the foregoing description is for the purpose of illustration only, and not for the purpose of limitation.

1. A composition comprising:
(a) a liquid matrix;
(b) a compatibilizing agent, said compatibilizing agent comprising:
(b1) one or more first groups, wherein each of the one or more first groups comprises an aryl sulfonyl moiety; and
(b2) one or more second groups, wherein each of the one or more second groups comprises an alkyl moiety, a polymeric or oligomeric moiety, or a combination thereof, and wherein each of the one or more second groups is attached to at least one of the one or more first groups; and
(c) one or more optional additional components.

2. The composition of claim 1, wherein the polymeric moiety of the one or more second groups is selected from the group consisting of a polyether, a polysiloxane, a polyacrylate, a polyester, and a polyolefin.

3. The composition of claim 1, wherein compatibilizing agent (b) has a structure of one of Formulas (I)—(V): 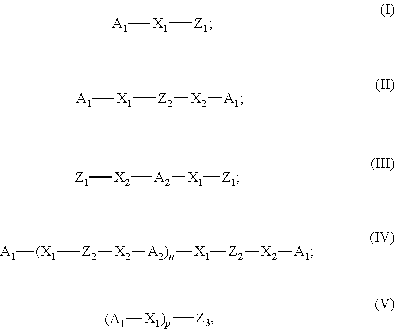
wherein
n is an integer of 1 or greater;
p is an integer of 3 or greater;
each A₁ is aryl or substituted aryl;
each A₂ is arylene or substituted arylene;
each X₁ is —S(═O)₂—NH—C(═O)-Q- or —S(═O)₂—NH—C(═O)—;
each X₂ is -Q-(C═O)—NH—S(═O)₂— or —C(═O)—NH—S(═O)₂—;
each Q is O or NH;
Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl;
Z₂ is alkylene, a polymeric or oligomeric moiety, or a combination thereof; and
Z₃ is a multivalent group derived from a compound comprising at least three hydroxy, amino, or carboxylic acid groups.

4. The composition of claim 1, wherein the liquid matrix comprises water, an oil, a hydrocarbon fluid, an organic solvent, or a combination thereof.

5. The composition of claim 1, wherein the liquid matrix comprises a reactive or non-reactive resin, an oligomer, a polymer, an amine, an alcohol, an isocyanate, a polyol, or a combination thereof; optionally wherein the liquid matrix comprises a polyether, a polyester, a polyol, a polyalphaolefin (PAO), an isocyanate resin, an urethane resin, a silicone resin, an acrylic resin, an epoxy resin, and a silyl-terminated resin.

6. The composition of claim 1, wherein optional additional component (c) comprises solid organic and/or inorganic particles and/or fibers, optionally wherein component (c) comprises one or more particles and/or fibers selected from the group consisting of silicon dioxide, fumed silica, fused silica, talc, mica, wollastonite, calcium carbonate, carbon, a polymer, aluminum, aluminum trihydride (ATH), iron, silver, a metal oxide, boron nitride and aluminum nitride.

7. The composition of claim 1, wherein optional additional component (c) comprises an additional liquid component, wherein said additional liquid component is a liquid that is incompatible with liquid matrix (a).

8. The composition of claim 1, wherein the compatibilizing agent has a structure of Formula (I):
A₁-X₁—Z₁ (I);
wherein
A₁ is aryl or substituted aryl;
X₁ is —S(═O)₂—NH—C(═O)—O—, —S(═O)₂—NH—C(═O)—NH—, or —S(═O)₂—NH—C(═O)—;
Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl.

9. The composition of claim 8, wherein A₁ is phenyl or methyl-substituted phenyl.

10. The composition of claim 8, wherein Z₁ is alkyl, optionally isostearyl.

11. The composition of claim 8, wherein Z₁ is -(L₂)ₛ-(L₃)ₜ-R₁, wherein s is 0, t is 1, L₃ is a polyether polyol moiety, and R₁ is C1-C6 alkyl.

12. The composition of claim 8, wherein Z₁ is -(L₂)ₛ-(L₃)ₜ-R₁, wherein s is 1, t is 1, L₂ is alkylene, L₃ is a polysiloxane moiety, and R₁ is silyl.

13. The composition of claim 8, wherein the compatibilizing agent has a structure of Formula (Ia): 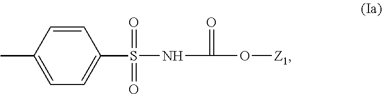
wherein Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl.

14. The composition of claim 8, wherein A₁ is methyl-substituted phenyl, X₁ is —S(═O)₂—NH—C(═O)—O—, and Z₁ is -(L₂)ₛ-(L₃)ₜ-R₁ where s is 0, t is 1, L₃ is a polyether polyol moiety, and R₁ is methyl; and wherein liquid matrix (a) comprises a polyether polyol and optional additional component (c) comprises one or more organic and/or inorganic particles, optionally ATH particles.

15. The composition of claim 8, wherein A₁ is methyl-substituted phenyl, X₁ is —S(═O)₂—NH—C(═O)—NH—, and Z₁ is -(L₂)ₛ-(L₃)ₜ-R₁ where s is 0, t is 1, L₃ is a polyether polyol, and R₁ is methyl; and wherein liquid matrix (a) comprises a polyether polyol and optional additional component (c) comprises one or more organic and/or inorganic particles, optionally ATH particles.

16. The composition of claim 8, wherein A₁ is methyl-substituted phenyl, X₁ is —S(═O)₂—NH—C(═O)—O—, and Z₁ is isostearyl; and wherein liquid matrix (a) comprises a PAO, and optional additional component (c) comprises one or more organic and/or inorganic particles, optionally iron particles.

17. The composition of claim 8, wherein A₁ is methyl-substituted phenyl, X₁ is —S(═O)₂—NH—C(═O)—O—, and Z₁ is -(L₂)ₛ-(L₃)ₜ-R₁ where s is 1, t is 1, L₂ is —CH₂CH₂—OCH₂CH₂CH₂—, L₃ is a polydimethylsiloxane (PDMS) moiety, and R₁ is silyl; and wherein liquid matrix (a) comprises a silicone resin, and optional additional component (c) comprises one or more organic and/or inorganic particles, optionally ATH particles.

18. The composition of claim 8, wherein A₁ is methyl-substituted phenyl, X₁ is —S(═O)₂—NH—C(═O)—O—, and Z₁ is isostearyl; and wherein liquid matrix (a) comprises an isocyanate, optionally HDMI; and optional additional component (c) comprises one or more organic and/or inorganic particles, optionally ATH particles.

19. The composition of claim 8, wherein A₁ is methyl-substituted phenyl, X₁ is —S(═O)₂—NH—C(═O)—O—, and Z₁ is polyoxyethylene (5) oleyl ether; and wherein liquid matrix (a) comprises water; and optional additional component (c) comprises a PAO.

20. The composition of claim 1, wherein said composition is selected from the group consisting of a paint, a coating, a cleaning solution, a lubricant, a magneto rheological fluid, an adhesive, a drilling fluid, a cosmetic fluid, and an ink.

21. A method of modifying the viscosity of a polymer resin composition, the method comprising contacting a composition comprising a polymer resin with a compatibilizing agent, wherein said compatibilizing agent comprises:
(b1) one or more first groups, wherein each of the one or more first groups comprises an aryl sulfonyl moiety; and
(b2) one or more second groups, wherein each of the one or more second groups comprises an alkyl group, a polymeric or oligomeric group, or a combination thereof, and wherein each of the one or more second groups is attached to at least one of the one or more first groups.

22. The method of claim 21, wherein the compatibilizing agent has a structure of Formula (I): 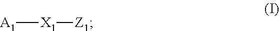
wherein
A₁ is an aryl or substituted aryl group;
X₁ is selected from the group consisting of —S(═O)₂—NH—C(═O)-Q- or —S(═O)₂—NH—C(═O)—;
Q is O or NH; and
Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl.

23. The method of claim 21, wherein the polymer resin comprises solid organic and/or inorganic filler particles and/or fibers.

24. The method of claim 23, wherein the solid organic and/or inorganic filler particles and/or fibers comprise one or more of silicon dioxide, fumed silica, fused silica, talc, mica, wollastonite, calcium carbonate, carbon black, carbon fibers, polymer fibers, aluminum, aluminum trihydride (ATH), iron, silver, a metal oxide, boron nitride and aluminum nitride.

25. The method of claim 21, wherein the polymer resin comprises a polyol, an isocyanate, an amine, a polysiloxane, a polyalphaolefin, an epoxy resin, or an acrylic resin.

26. A method of preparing a polyurethane, wherein the method comprises contacting a composition comprising a polyol and/or an isocyanate resin with a compatibilizing agent, wherein said compatibilizing agent comprises:
(b1) one or more first groups, wherein each of the one or more first groups comprises an aryl sulfonyl moiety; and
(b2) one or more second groups, wherein each of the one or more second groups comprises an alkyl moiety, a polymeric or oligomeric moiety, or a combination thereof, and wherein each of the one or more second groups is attached to at least one of the one or more first groups.

27. The method of claim 26, wherein the compatibilizing agent has a structure of Formula (I): 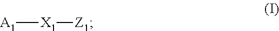
wherein:
A₁ is an aryl or substituted aryl group;
X₁ is selected from the group consisting of —S(═O)₂—NH—C(═O)-Q- or —S(═O)₂—NH—C(═O)—;
Q is O or NH; and
Z₁ is selected from alkyl and -(L₂)ₛ-(L₃)ₜ-R₁, wherein s is 0 or 1; t is 0 or 1; L₂ is alkylene, L₃ is a polymeric or oligomeric group, optionally a polyether or polysiloxane group, and R₁ is alkyl or silyl.

28. The method of claim 26, wherein the method further comprises contacting the composition with one or more organic and/or inorganic filler particles and/or fibers.

29. The method of claim 28, wherein the one or more organic and/or inorganic filler particles and/or fibers comprise one or more of silicon dioxide, fumed silica, fused silica, talc, mica, wollastonite, calcium carbonate, carbon black, carbon fibers, polymer fibers, aluminum, aluminum trihydride (ATH), iron, silver, a metal oxide, boron nitride and aluminum nitride.

30. The method of claim 26, wherein the method further comprises contacting the composition with a catalyst.

31. The method of claim 26, wherein the compatibilizing agent is contacted to the composition comprising the polyol and/or isocyanate resin in an amount of about 0.05% by volume to about 49% by volume based on the total volume of liquid comprising the composition comprising the polyol and/or isocyanate resin and the compatibilizing agent.

32. A compound having a structure of one of Formulas (I)—(V): 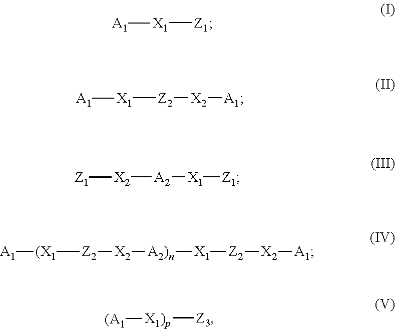
wherein
n is an integer of 1 or greater;
p is an integer of 3 or greater;
each A₁ is aryl or substituted aryl;
each A₂ is arylene or substituted arylene;
each X₁ is —S(═O)₂—NH—C(═O)-Q- or —S(═O)₂—NH—C(═O)—;
each X₂ is -Q-(C═O)—NH—S(═O)₂— or —C(═O)—NH—S(═O)₂—;
each Q is O or NH;
Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl;
Z₂ is alkylene, a polymeric or oligomeric moiety, or a combination thereof; and
Z₃ is a multivalent group derived from a compound comprising at least three hydroxy, amino, or carboxylic acid groups.

33. The compound of claim 32, wherein the compound has a structure of Formula (I): 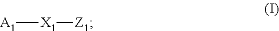
wherein
A₁ is aryl or substituted aryl;
X₁ is —S(═O)₂—NH—C(═O)—O—, —S(═O)₂—NH—C(═O)—NH—, or —S(═O)₂—NH—C(═O)—;
Z₁ is selected from alkyl and -(L₂)ₛ-(L₃)ₜ-R₁, wherein s is 0 or 1; t is 0 or 1; L₂ is alkylene, L₃ is a polymeric or oligomeric moiety, and R₁ is alkyl or silyl.

34. The compound of claim 33, wherein A₁ is phenyl or methyl-substituted phenyl.

35. The compound of claim 33, wherein X₁ is —S(═O)₂—NH—C(═O)—O—,

36. The compound of claim 33, wherein Z₁ is alkyl, optionally C8-C40 alkyl.

37. The compound of claim 33, wherein Z₁ is -(L₂)ₛ-(L₃)ₜ-R₁, wherein s is 0 or 1; t is 1; L₂ is alkylene, L₃ is a polymeric or oligomeric group, optionally a polyether or polysiloxane group, and R₁ is alkyl or silyl.

38. The compound of claim 33, wherein Z₁ is selected from isostearyl, an alkyl-terminated polyether polyol, and an alkylene-polysiloxane moiety.

39. The compound of claim 38, wherein the compound is selected from the group consisting of: 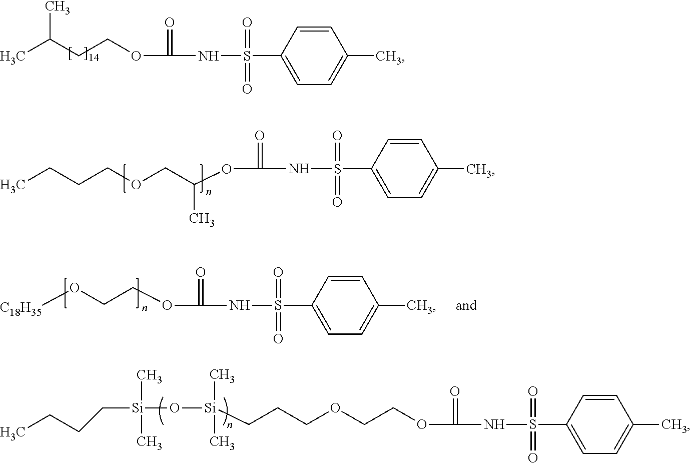
wherein n is an integer greater than 1.
